(19) United States
(12) Patent Application Publication
(10) Pub. No.: US 2025/0323290 A1
(43) Pub. Date: Oct. 16, 2025

(54) Fuel Storage Structures and Integration Method in Fuel Cell Systems

(71) Applicant: Infintium Fuel Cell Systems, Inc., Greenville, SC (US)

(72) Inventors: Ryan Victor Feltman, Anderson, SC (US); Brian Anthony Robinson, Simpsonville, SC (US)

(21) Appl. No.: 19/030,772

(22) Filed: Jan. 17, 2025

Related U.S. Application Data
(60) Provisional application No. 63/634,074, filed on Apr. 15, 2024.

(51) Int. Cl. H01M 8/04082; H01M 8/04746; H01M 8/2475

(52) U.S. Cl. CPC H01M 8/04201; H01M 8/04753; H01M 8/04776; H01M 8/2475

(57) ABSTRACT

A fuel storage structure in a fuel cell system includes a lower casting with a first groove and a second groove formed on an upper surface of the lower casting. A first lower isolator is positioned within the first groove and a second lower isolator is positioned within the second groove. A fuel storage tank is positioned above the lower casting and is supported by the first lower isolator and the second lower isolator.

### CROSS-REFERENCE TO RELATED APPLICATIONS

This patent application claims priority to U.S. Provisional Application No. 63/634,074, filed on Apr. 15, 2024 and entitled “Fuel Storage Structures and Integration Method in Fuel Cell Systems,” which is incorporated herein by reference as if reproduced in its entirety.

### TECHNICAL FIELD

The present disclosure relates generally to the field of fuel cell systems, and in particular embodiments, to fuel storage structures and integration methods in fuel cell systems.

### BACKGROUND

Fuel cell systems are power supply systems designed to generate electricity through a chemical reaction between a fuel and an oxidizing agent. As an example, a fuel cell system may use hydrogen as the fuel and oxygen from the air as the oxidizer, producing only water and heat generated as byproducts. Compared to traditional combustion-based power generation technologies, fuel cell systems generate electricity with lower emissions. Compared to batteries or combustion engines, fuel cells are more efficient, and eliminate the need to change, charge or manage batteries, which saves both labor and space. Other advantages of fuel cell systems include higher energy density, extended lifespan, rapid refueling/recharging capabilities, environmentally friendly operation, enhanced efficiency, scalability, and more. Fuel cell systems offer a clean, efficient, and versatile solution for a wide range of power generation applications, e.g., providing backup power, providing power supply in remote locations, such as spacecraft, remote weather stations, large parks, communications centers, rural locations, and so on, and powering fuel cell vehicles, such as forklifts, automobiles, buses, trains, boats, motorcycles, and so on.

It is thus desirable to develop techniques and mechanisms to improve performance of fuel cell systems in various aspects, and to facilitate utilization of fuel cell systems.

### SUMMARY

Technical advantages are generally achieved, by embodiments of this disclosure which describe innovative fuel storage structures and integration methods in fuel cell systems.

In accordance with one aspect of the present disclosure, a fuel storage structure in a fuel cell system is provided, which includes: a lower casting comprising a first groove and a second groove formed on an upper surface of the lower casting; a first lower isolator positioned within the first groove and a second lower isolator positioned within the second groove; and a fuel storage tank positioned above the lower casting, wherein the fuel storage tank is supported by the first lower isolator and the second lower isolator.

In accordance with another aspect of the present disclosure, a method for integrating a fuel storage structure in a fuel cell system is provided, which includes: forming a first groove and a second groove on an upper surface of a lower casting; placing a first lower isolator into the first groove and a second lower isolator into the second groove; and placing a fuel storage tank above the lower casting, supported by the first lower isolator and the second lower isolator.

In accordance with another aspect of the present disclosure, a fuel cell system is provided, which includes: a fuel storage tank; a lower casting positioned under the fuel storage tank; a plurality of lower isolators, each positioned within a respective groove in the lower casting and aligned parallel to a longitudinal axis of the fuel storage tank; a pressure regulator configured to control a fuel pressure within the fuel cell tank; a fuel cell stack configured to receive fuel from the fuel storage tank and generate electrical power; and a system controller configured to monitor and control the operation of the fuel storage system.

Features described in the context of one embodiment may be used in combination with other embodiments. For example, each of the optional features described above in the context of the apparatus may be used in combination with the system. Each of the optional features described above in the context of the method may be used in combination with the system. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an exemplary fuel cell system in a perspective view according to embodiments of the present disclosure;

FIG. 2 is a schematic block diagram of the fuel cell system in FIG. 1;

FIG. 3 is a perspective view illustrating an exemplary fuel storage structure and method for a fuel cell system according to embodiments of the present disclosure;

FIG. 4 is a cross-sectional view of an exemplary fuel storage structure and method for a fuel cell system according to embodiments of the present disclosure;

FIG. 5 is a perspective view from beneath an upper casting of an exemplary fuel storage structure and method for a fuel cell system according to embodiments of the present disclosure;

FIG. 6 is a top view of a lower casting of an exemplary fuel storage structure and method for a fuel cell system according to embodiments of the present disclosure;

FIG. 7 is a cross-sectional view of an exemplary fuel storage structure and method for a fuel cell system according to embodiments of the present disclosure;

FIG. 8 is a top view of the lower casting of an exemplary fuel storage structure and method for a fuel cell system according to embodiments of the present disclosure;

FIG. 9 is a top view of the lower casting of an exemplary fuel storage structure and method for a fuel cell system according to embodiments of the present disclosure;

FIG. 10 is a top view of the lower casting of an exemplary fuel storage structure and method for a fuel cell system according to embodiments of the present disclosure;

FIG. 11 is a cross-sectional view of an exemplary fuel storage structure and method for a fuel cell system according to embodiments of the present disclosure;

FIG. 12 is an exploded view of an exemplary fuel storage structure and method for a fuel cell system according to embodiments of the present disclosure; and

FIG. 13 is a flowchart of an example method of integrating a fuel storage structure in a fuel cell system according to embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

In addition, terms “first”, “second”, and so on, are only used to distinguish one feature (e.g., one entity or operation) from another feature (e.g., another entity or operation), and should not be interpreted as indicating or implying a relative importance, an order, or a quantity of indicated features. A feature limited with “first” or “second” may explicitly indicate or implicitly include one or more of the features.

Fuel cell systems typically utilize an energy storage device, such as a fuel storage tank, to store fuel (e.g., hydrogen) until it is needed for electricity generation within the fuel cell system. In the design and integration of energy storage devices for fuel cell vehicles like forklift trucks, meeting minimum weight standards is crucial to ensure the vehicle maintains optimal traction, braking, and counterbalancing capabilities during material handling operations. To achieve compliance with these weight requirements, energy storage devices are often comprised of upper and lower castings that encapsulate a fuel storage tank in the center. These castings play a vital role in providing structural support and facilitating a balanced weight distribution, thereby significantly enhancing the vehicle's stability during operation.

A fuel storage tank may undergo expansion or contraction due to changes in environmental temperature, thus it is important to design the mounting system with features that allow for this thermal expansion and contraction while maintaining the structural integrity and stability of the fuel storage tank within its housing. However, challenges arise in securely and precisely positioning the fuel storage tank and facilitating the convergence of the upper and lower castings, and dampening vibrations while allowing room for thermal expansion and contraction of the fuel storage tank due to environmental temperature changes.

When mounting fuel storage tanks, particularly Type 1 tanks utilized in industrial applications, in fuel cell systems, conventional methods primarily rely on the use of rubber pads. These pads, typically 1/16″ thick, serve the primary function of securing the fuel storage tank in its position within the housing. However, these pads often fail to precisely position the fuel storage tank and to serve as a buffer or barrier between the fuel storage tank and the surrounding upper casting and lower casting to effectively dampen vibration while accommodating factors such as thermal expansion and contraction.

Thus, there is a need for a mounting structure and method capable of addressing these challenges effectively.

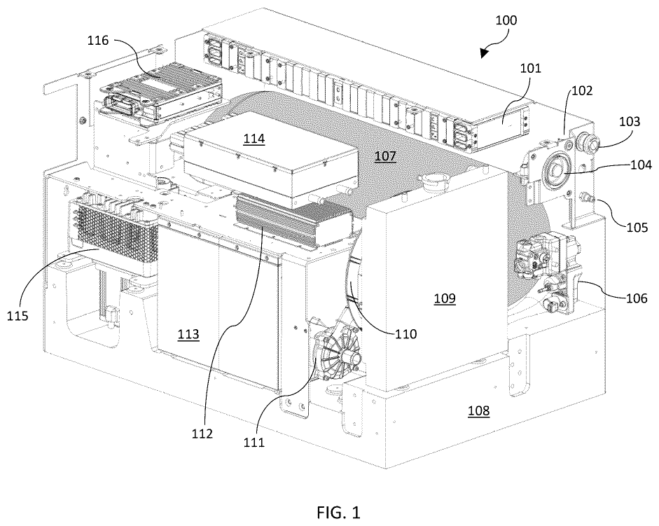

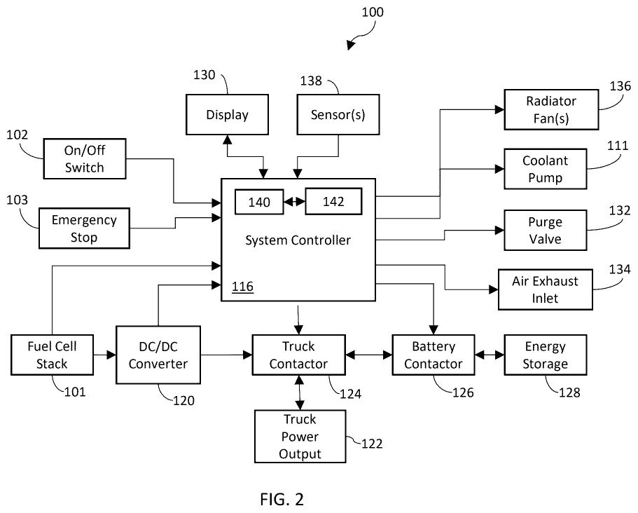

The following description is provided with reference to FIG. 1 and FIG. 2. FIG. 1 is a diagram of an exemplary fuel cell system 100 in a perspective view according to embodiments of the present disclosure. FIG. 2 is a schematic block diagram of the fuel cell system 100 in FIG. 1, which shows an example implementation of the fuel cell power supply system. In this example, the fuel cell power supply system uses hydrogen as the fuel. However, hydrogen is merely used as an example for illustration purpose. Any other fuel applicable for fuel cell power systems may also be used. The terms of “fuel cell power supply system”, “fuel cell system” and “system” are used interchangeably in the present disclosure.

The fuel cell system 100 as shown in FIG. 1 may include an fuel cell stack 101, an on/off switch 102, an emergency stop switch 103, a fill port 104, a drain port 105, a pressure regulator 106, a fuel storage tank 107, a system base frame 108, radiator assembly 109, a radiator fan 110, a coolant pump 111, a low power dc/dc converter 112, a battery 113, a high power dc/dc converter 114, an air compressor 115, and a system controller 116. The fuel cell system 100 may further include a truck power output 122, a truck contactor 124, a battery contactor 126, an energy storage device 128, a display 130, a purge valve 132, and an air exhaust inlet 134, which are not shown in FIG. 1.

Components of the fuel cell system 100 in this example are mainly arranged on or above the system base frame 108 in a system housing (not shown). The fuel cell stack 101 may be arranged close to a rear plate of the fuel cell system 100. As an example, the fuel cell stack 101 may be mounted on the rear plate. The rear plate may be part of the system housing. The fuel cell stack 101 may include one or more fuel cells, which may be combined in series into a fuel cell stack (stacked on top of each other) as typically used. A fuel cell is an electrochemical cell that converts the chemical energy of a fuel (e.g., hydrogen) and an oxidizing agent (e.g., oxygen) into electricity. As well known, a fuel cell typically includes an anode, cathode, and an electrolyte membrane. In operation, hydrogen is passed through the anode and oxygen is passed through the cathode. At the anode, a catalyst splits the hydrogen molecules into electrons and protons. The protons pass through the porous electrolyte membrane, while the electrons pass through a circuit, generating an electric current. At the cathode, the protons, electrons, and oxygen combine to produce water and heat. A typical fuel cell stack may include hundreds of fuel cells. The amount of power produced by a fuel cell may depend upon various factors, such as the fuel cell type, the fuel cell size, the temperature at which it operates, and the pressure of the gases supplied to the fuel cells, and so on.

The on/off switch 102 is used to turn on or off the fuel cell system 100. The emergency stop switch 103 is configured to stop operation of the fuel cell system 100 immediately in case of emergency, e.g., by cutting off the supply of the fuel.

The fuel (i.e., hydrogen) of the fuel cell system 100 is stored in the fuel tank 107. The fuel tank 107 may be arranged below the fuel cell stack 101. Hydrogen may be filled into the fuel tank 107 through the fill port 104. Fuel exhaust may be discharged through the drain port 105. The fuel exhaust may primarily include water and non-reactive components, such as traces of unreacted hydrogen, and possible impurities entering the fuel. The drain port 105 may be closed by the purge valve 132 (not shown in FIG. 1), which will temporarily be opened during purge of the fuel cell stack 101 for discharging the fuel exhaust. Fuel stored in the fuel tank 107 is maintained at a certain pressure level, which may be adjusted through the pressure regulator 106.

The radiator assembly 109 is configured to manage the temperature of the fuel cell system 100 by dissipating excess heat generated during the electrochemical reactions that occur within the fuel cell stack 101. The radiator assembly 109 may include cooling components such as the radiator fan 110 for dissipating heat and the coolant pump 111 for pumping coolant. Hot/warm exhaust air from the fuel cell stack 101 may enter the air exhaust inlet 134 at the radiator assembly 109, be cooled down through the radiator assembly 109, and be re-circulated back to the fuel cell stack 101.

The amount of air available for the electrochemical reaction at the fuel cell stack 101 affects the performance of the fuel cell system 100. Fuel cell performance improves as the pressure of the reactant gases increases. The air compressor 115 is used to push air into the fuel cell stack 101 such that the air is provided to the fuel cell stack 101 at a desired flow rate. As an example, the air compressor 115 may raise the pressure of the incoming air of the fuel cell stack 101 to about 2˜4 times the ambient atmospheric pressure of the fuel cell stack 101.

The fuel cell stack 101 is coupled to a DC/DC converter 120 including the low power DC/DC converter 112 and the high power DC/DC converter 114. Fuel cells produce electricity in the form of direct current (DC). The electric power generated by the fuel cell stack 101 may be converted to different levels of DC power to match various load requirements by the DC/DC converter 120, e.g., to low DC power and high DC power by the low power DC/DC converter 112 and the high power DC/DC converter 114, respectively. The output of the DC/DC converter 120 may be a current or voltage. As an example, the DC/DC converter 120 may be configured to convert a DC voltage output by the fuel cell stack 101 to desired voltage(s). The fuel cell system 100 may include various numbers of DC/DC converters depending on the designs and applications of the fuel cell system 100.

The DC/DC converter 120 may include a communication module, an input voltage measurement module, an input current measurement module, an output voltage measurement module, and/or an output current measurement module. In some embodiments, the DC/DC converter 120 may control, according to the communication data of the communication module, specific numerical values of the output current and voltage, and output, through the communication module, data such as input voltages, input currents, output voltages, output currents, etc. The state data of the DC/DC converter 120 may include DC/DC input currents, and/or DC/DC input voltages.

The DC/DC converter 120 may be connected to the truck power output 122 through the truck contactor 124. The truck contactor 124 may be a normal open type high-current contactor. The fuel cell system 100 supplies the electric energy generated by the fuel cell stack 101 to external devices/apparatus (referred to as external power receivers thereafter) through the truck power output 122.

The DC/DC converter 120 may also be connected to the energy storage device 128 through the truck contactor 124 and the battery contactor 126. The electric energy generated by the fuel cell stack 101 may be stored in the energy storage device 128, e.g., the battery 113. The energy stored in the energy storage device 128 may also be supplied to the external power receivers through the battery contactor 126, the truck contactor 124 and the truck power output 122.

The system controller 116 is configured to manage and control operation of the fuel cell system 100. The system controller 116 may include one or more processors 140, such as microprocessors or microcontrollers, which are appropriately configured to carry out fuel cell system operations. The system controller 116 may further include a computer-readable storage device 142 storing computer-readable instructions, which may be executed by the one or more processors 140 of the system controller 116 for carrying out the fuel cell system operations. The computer-readable storage device 142 may include any non-transitory mechanism for storing information in a form readable by a machine (e.g., a computer, a processor). For example, a computer-readable storage device may include read-only memory (ROM), random-access memory (RAM), magnetic disk storage media, optical storage media, flash-memory devices, solid state storage media, and other storage devices and media.

The system controller 116 may be a controller with an integrated design, which may be a scattered fuel cell controller, a whole vehicle controller, or a battery energy management system. The system controller 116 may include an energy management unit, a fuel cell control unit, an energy storage device monitoring unit, a hydrogen safety monitoring unit, a system failure monitoring unit and/or a startup control unit.

As shown in FIG. 2, the system controller 116 may be connected to various components of the fuel cell system 100, such as the on/off switch 102, the emergency stop 103, the fuel cell stack 101, the DC/DC converter 120, radiator fan(s) 136 such as the radiator fan 110, the coolant pump 111, the purge valve 132, the air exhaust inlet 134, the truck power output 124 through the truck contactor 124, and the energy storage 128 through the battery contactor 126.

As an example, when the on/off switch 102 is switched off, the system controller 116 may receive a signal indicating the switching off of the on/off switch 102, and control to stop operations of the fuel cell system 100, e.g., cutting off the fuel supply to the fuel cell stack 101, turning off the radiator fan(s) 136, and so on. As another example, the system controller 116 may control supplying power to external power receiver(s) and storing energy in the energy storage device 128. As yet another example, the system controller 116 may control to close and open the purge value 132 to discharge fuel exhaust.

The system controller 116 may be connected to the display 130, through which users/operators may interact with the fuel cell system 100. For example, a user may enter instructions through the display 130 and/or set parameter(s) for operations of the fuel cell system 100. A user may monitor operation status or parameters/information displayed on the display 130. The display 130 may be integrated with the system controller 116.

The system controller 116 may be connected to one or more sensors 138. The sensor(s) 138 may include various devices for detecting/sensing/measuring parameters of the fuel cell system 100, such as thermometer(s), timer(s), gas density sensor(s)/meter(s), moisture meter(s), and so on. The sensor(s) 138 may be positioned at various locations depending on their purposes.

The fuel storage structure comprises a fuel storage tank 400, an upper casting 410, a lower casting 420, and a plurality of isolators (or mounts). The terms of “isolator” and “mount” are used herein interchangeably. The plurality of isolators are positioned between the castings and the fuel storage tank to provide support, alignment, and vibration isolation. The lower casting 420 serves as the primary support structure for the fuel storage tank, ensuring structural stability and alignment for the fuel cell system. The upper casting 410 functions as the top enclosure, designed to align precisely with and fit over the lower casting 420. Together, the upper casting 410 and lower casting 420 encapsulate the fuel storage tank 400 securely within the structure, forming a rigid and protective housing. In some embodiments, the lower casting 420 may be integrated into the system base frame 108, forming an inseparable part of the system base frame 108.

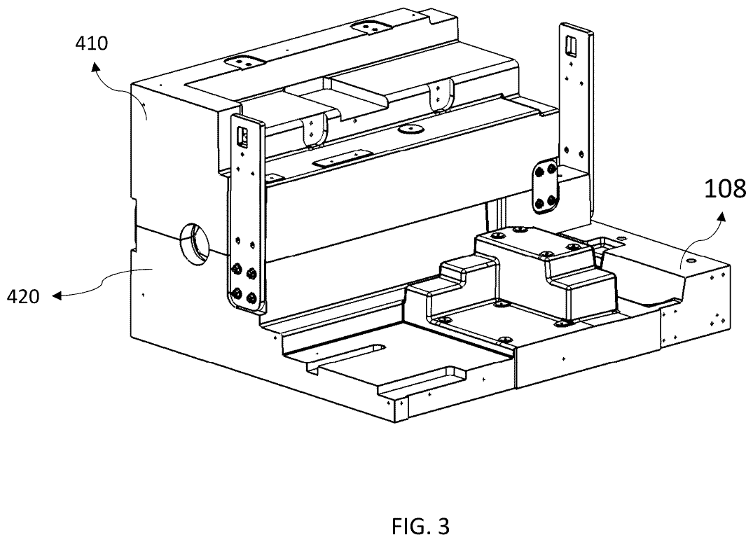

FIG. 3 illustrates a perspective view of an exemplary fuel storage structure and method employed in a fuel cell system according to embodiments of the present disclosure. This figure depicts the configuration where the upper casting 410 and lower casting 420 are closed together to form a secure and protective enclosure for the fuel storage tank 400 and associated components.

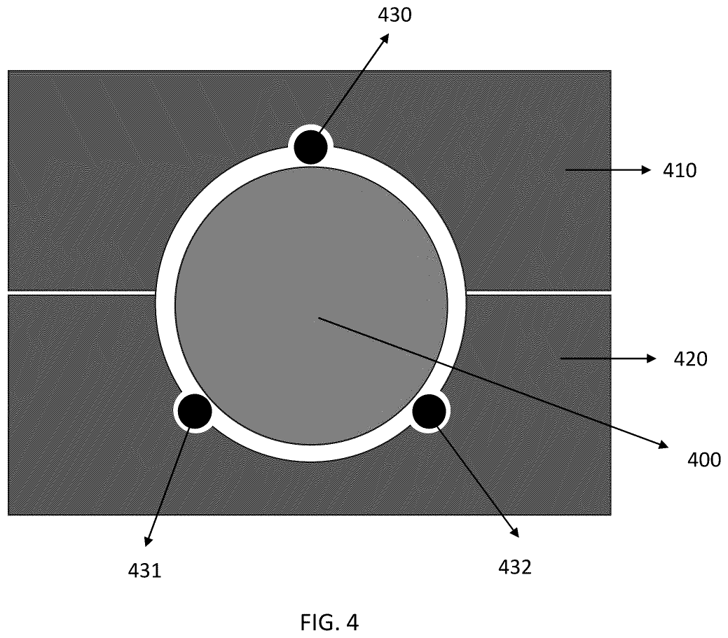

FIG. 4 illustrates a cross-sectional view of an exemplary fuel storage structure and method for a fuel cell system according to embodiments of the present disclosure. The fuel storage structure comprises a fuel storage tank 400, an upper casting 410, a lower casting 420, and three isolators (or mounts): an upper mount 430 and two lower mounts 431 and 432. The three isolators (430, 431, and 432) are placed around the fuel storage tank 400 along the longitudinal direction of the fuel storage tank 400. The isolators (430, 431, and 432) may be placed approximately in parallel to the longitudinal direction of the fuel storage tank 400. The upper mount 430 may be placed into a groove that is either cast or machined into the upper casting 410, and the two lower mounts 431 and 432 may be placed into grooves that are either cast or machined into the lower casting 420. In some embodiments, the grooves may have a semi-circular or arcuate profile that extends along the surface of the upper casting 410 or the lower casting 420. The upper mount 430 may be located on the apex of the upper radius defined by the upper casting 410, whereas the two lower mounts 431 and 432 may be positioned symmetrically around the centerline axis of the fuel storage tank 400. In some embodiments, the three isolators (430, 431, and 432) may be evenly spaced, so that the distances between each two of the isolators are equal. In some embodiments, the lengths of the three isolators may be substantially equal to or less than the length of the straight cylindrical portion of the fuel storage tank 400. In some embodiments, the groove for the upper isolator 430 may have an opening smaller than the diameter of the upper isolator 430. This configuration allows the upper isolator 430 to be securely retained within the groove, ensuring that it does not easily come loose or dislodge during operation. Similarly, the openings of the grooves for the lower isolators 431 and 432 may also be smaller than the diameter of their respective isolators. In some embodiments, the upper mount 430 may be bolted or adhered to the upper casting 410, and the two lower mounts 431 and 432 may be bolted or adhered to the lower casting 420.

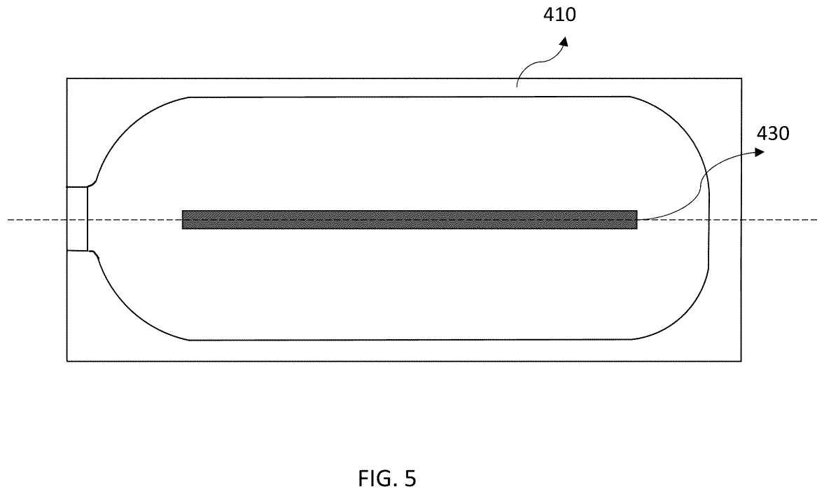

FIG. 5 illustrates a view from beneath the upper casting 410 of an exemplary fuel storage structure with one upper mount according to embodiments of the present disclosure. The upper casting 410 includes a groove integrated into its structure, which may be either cast or machined to ensure precision and durability. The groove is centrally aligned along the longitudinal axis of the tank. In some embodiments, the groove may have a semi-circular or arcuate profile that extends along the surface of the upper casting 410. In some embodiments, the groove may span the entire length of the straight cylindrical portion of the fuel storage tank 400. Alternatively, in other embodiments, the length of the groove may be shorter than the full length of the straight cylindrical portion of the fuel storage tank 400. The upper mount 430 is securely positioned within the groove to provide stable contact and support for the fuel storage tank 400. In some embodiments, the length of the upper mount 430 may be substantially equal to or less than the length of the straight cylindrical portion of the fuel storage tank 400. In some embodiments, as illustrated in FIG. 5, the left end of the upper mount 430 may align with the left end of the straight cylindrical portion of the fuel storage tank 400, while the right end of the upper mount 430 may align with the right end of the straight cylindrical portion of the fuel storage tank 400.

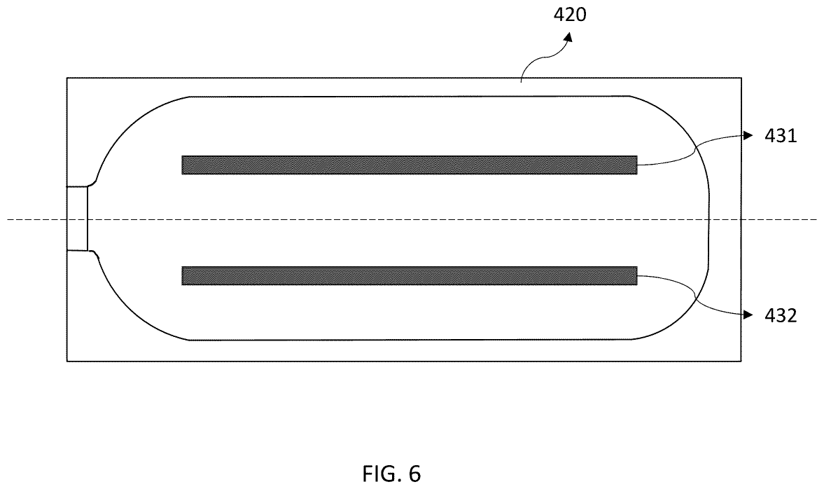

FIG. 6 illustrates a top view of the lower casting of an exemplary fuel storage structure with two lower mounts according to embodiments of the present disclosure. The lower casting 420 includes two grooves integrated into its structure, which may be either cast or machined to ensure precision and durability. The two grooves are parallel to each other along the longitudinal axis of the fuel storage tank 400. In some embodiments, the grooves may span the entire length of the straight cylindrical portion of the fuel storage tank 400. Alternatively, in other embodiments, the length of the grooves may be shorter than the full length of the straight cylindrical portion of the fuel storage tank 400. The two lower mounts, 431 and 432, are securely positioned within the grooves to provide secure alignment and support for the fuel storage tank 400. In some embodiments, as illustrated in FIG. 6, the lengths of the lower mounts 431 and 432 may be substantially equal to or less than the length of the straight cylindrical portion of the fuel storage tank 400. In some embodiments, as illustrated in FIG. 6, the left end of the lower mounts, 431 and 432, may align with the left end of the straight cylindrical portion of the fuel storage tank 400, while the right end of the lower mounts, 431 and 432, may align with the right end of the straight cylindrical portion of the fuel storage tank 400.

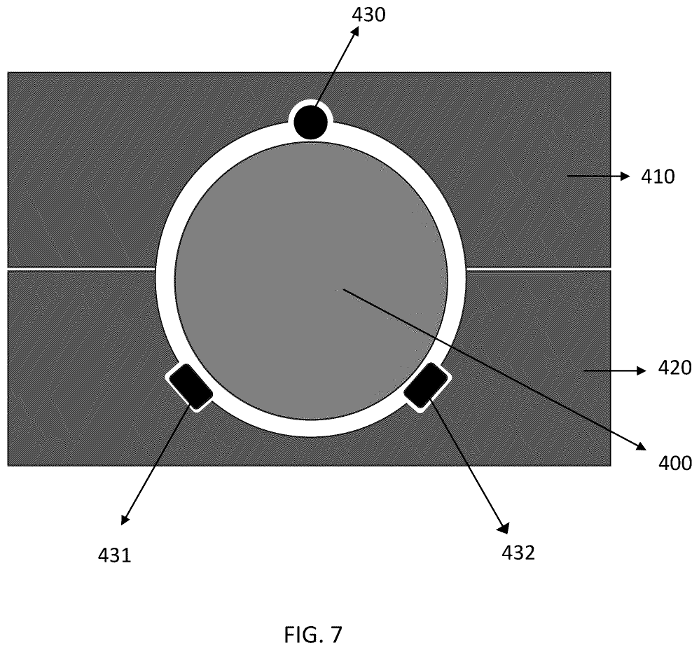

In some embodiments, the isolators can have different shapes, as shown in FIG. 7. FIG. 7 is a cross-sectional view of an exemplary fuel storage structure and method employed in a fuel cell system according to embodiments of the present disclosure. The upper mount 430 may be cylindrical in shape, while the two lower mounts 431 and 432 may be rectangular prisms. The three isolators (430, 431, and 432) are placed around the fuel storage tank 400 along the longitudinal direction of the fuel storage tank 400. The isolators (430, 431, and 432) may be placed approximately in parallel to the longitudinal direction of the fuel storage tank 400. The upper mount 430 may be placed into a groove that is either cast or machined into the upper casting 410, and the two lower mounts 431 and 432 may be placed into grooves that are either cast or machined into the lower casting 420. In some embodiments, the groove for the upper mount 430 may have a circular or semi-circular shape that extends along the surface of the upper casting 410, while the grooves for the lower mounts 431 and 432 may have a rectangular shape that extends along the surface of the lower casting 420. The upper mount 430 may be located on the apex of the upper radius defined by the upper casting 410, whereas the two lower mounts 431 and 432 may be positioned symmetrically around the centerline axis of the fuel storage tank 400. In some embodiments, the three isolators (430, 431, and 432) may be evenly spaced, so that the distances between each two isolators are equal. In some embodiments, the lengths of the three isolators may be substantially equal to or less than the length of the straight cylindrical portion of the fuel storage tank 400.

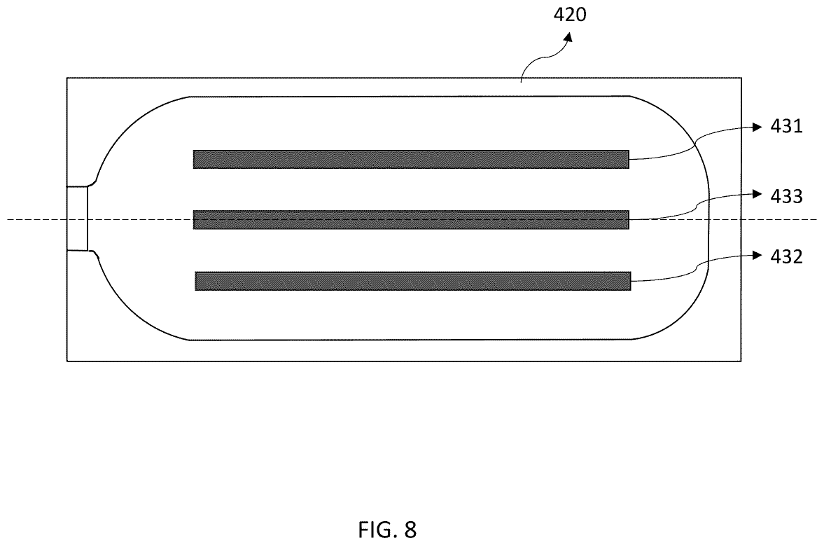

In some embodiments, there may be more than two lower mounts. FIG. 8 illustrates a top view of the lower casting of an exemplary fuel storage structure and method employed in a fuel cell system according to embodiments of the present disclosure. The lower casting 420 may comprise three grooves parallel to each other along the longitudinal axis of the fuel storage tank. In some embodiments, the grooves may span the entire length of the straight cylindrical portion of the fuel storage tank 400. Alternatively, in other embodiments, the length of the grooves may be shorter than the full length of the straight cylindrical portion of the fuel storage tank 400. The three lower mounts, 431, 432 and 433, are positioned within the grooves to provide secure alignment and support. In some embodiments, the lower mount 433 is positioned between the lower mounts 431 and 432, aligned with the central longitudinal axis of the fuel storage tank 400 and located at the lowest point of the lower casting 420. The three lower mounts (431, 432, and 433) may be evenly spaced from each other, ensuring uniform distribution. The lengths of the three lower mounts may be approximately equal to or less than the full length of the straight cylindrical portion of the fuel storage tank. In some embodiments, as illustrated in FIG. 8, the left end of the lower mounts, 431, 432 and 433, may align with the left end of the straight cylindrical portion of the fuel storage tank 400, while the right end of the lower mounts, 431, 432 and 433, may align with the right end of the straight cylindrical portion of the fuel storage tank 400.

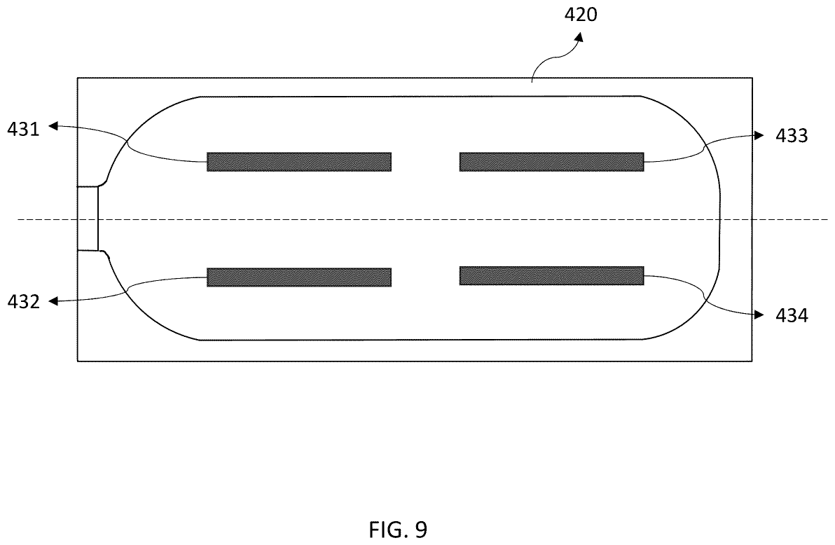

FIG. 9 illustrates a top view of the lower casting of an exemplary fuel storage structure and method employed in a fuel cell system according to embodiments of the present disclosure. The lower casting 420 may comprise four grooves running along the longitudinal axis of the fuel storage tank. As illustrated in FIG. 9, the grooves for the lower mounts 431 and 432 are located toward the left side of the lower casting 420 and are parallel to each other. Similarly, the grooves for the lower mounts 434 and 435 are located toward the right side of the lower casting 420 and are parallel to each other, mirroring the arrangement of isolators 431 and 432. The four lower mounts, 431, 432, 433 and 434, are positioned within the grooves to provide secure alignment and support. In some embodiments, the lower mounts 431 and 433 may be positioned along the same horizontal line on the lower casting 420, while the lower mounts 432 and 434 are positioned along another horizontal line. The lower mounts 431 and 432 may be positioned symmetrically around the centerline axis of the fuel storage tank 400. The lower mounts 433 and 434 may be positioned symmetrically around the centerline axis of the fuel storage tank 400. In some embodiments, the four lower mounts, 431, 432, 433 and 434, may have identical lengths, with each mount's length being less than half but greater than one-quarter of the length of the straight cylindrical portion of the fuel storage tank 400. The grooves for the lower mounts 431 and 432 are aligned vertically with a defined spacing between them. Similarly, the grooves for the lower mounts 433 and 434 are aligned vertically with a defined spacing between them. In some embodiments, as illustrated in FIG. 9, the left end of the lower mounts 431 and 432 may align with the left end of the straight cylindrical portion of the fuel storage tank 400, while the right end of the lower mounts 433 and 434 may align with the right end of the straight cylindrical portion of the fuel storage tank 400. In some other embodiments, the four lower mounts may have varying lengths. For instance, the length of the lower mount 431 may be longer than the length of the lower mount 433, while the length of the lower mount 432 may be shorter than the length of the lower mount 434. In such cases, the combined length of 431 and 432, as well as the combined length of 433 and 434, is more than half but less than the full length of the straight cylindrical portion of the fuel storage tank 400. The above configuration ensures that the lower mounts provide adequate support and stability while optimizing material usage and structural efficiency.

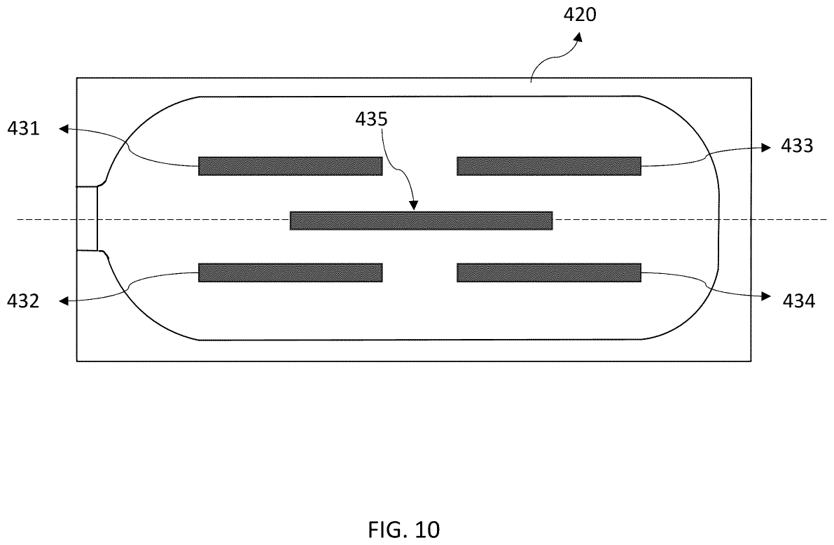

FIG. 10 illustrates a top view of the lower casting of an exemplary fuel storage structure and method employed in a fuel cell system according to embodiments of the present disclosure. The lower casting 420 may comprise five grooves running along the longitudinal axis of the fuel storage tank 400. As illustrated in FIG. 10, the grooves for the lower mounts 431 and 432 are located toward the left side of the lower casting 420 and are parallel to each other. The grooves for the lower mounts 433 and 434 are located toward the right side of the lower casting 420 and are parallel to each other, mirroring the arrangement of lower mounts 431 and 432. The groove for the lower mount 435 is positioned centrally, aligned with the central longitudinal axis of the fuel storage tank 400, and located at the lowest point of the lower casting 420. The five lower mounts, 431, 432, 433, 434, and 435, are positioned within their respective grooves to provide secure alignment and support for the fuel storage tank 400. In some embodiments, the lower mounts 431 and 433 may be positioned along the same horizontal line on the lower casting 420, while the lower mounts 432 and 434 are positioned along another horizontal line. The lower mounts 431 and 432 may be positioned symmetrically around the centerline axis of the fuel storage tank 400. The lower mounts 433 and 434 may be positioned symmetrically around the centerline axis of the fuel storage tank 400. In some embodiments, the four lower mounts, 431, 432, 433 and 434, may have identical lengths, with each mount's length being less than half but greater than one-quarter of the length of the straight cylindrical portion of the fuel storage tank 400. The grooves for the lower mounts 431 and 432 are aligned vertically with a defined spacing between them. Similarly, the grooves for the lower mounts 433 and 434 are aligned vertically with a defined spacing between them. In some embodiments, as illustrated in FIG. 10, the left end of the lower mounts, 431 and 432, may align with the left end of the straight cylindrical portion of the fuel storage tank 400, while the right end of the lower mounts, 433 and 434, may align with the right end of the straight cylindrical portion of the fuel storage tank 400. In some embodiments, the lower mount 435 may have a length that differs from that of the lower mounts 431, 432, 433, and 434. In some embodiments, as illustrated in FIG. 10, the left end of the lower mount 435 may align with the center line of the lower mounts 431 and 432, while the right end of the lower mount 435 may align with the center line of the lower mounts 433 and 434. This configuration ensures a balanced positioning and alignment of the lower mount 435 relative to the surrounding lower mounts. In some other embodiments, the five lower mounts may have varying lengths.

In some embodiments, after the isolators are installed into their respective grooves, a portion of each isolator may protrude outward from the groove surface. After the fuel storage tank 400 is installed, the isolators are depressed into their respective grooves, such that their outer surfaces become substantially flush with the adjacent surfaces of the castings. This configuration ensures proper alignment and mechanical engagement of the isolators within the grooves. Taking FIG. 7 as an example, the lower isolators 431 and 432 extend partially outside the grooves on the lower casting 420, with a portion of their height protruding above the adjacent surface of the lower casting 420. The upper isolator 430 extends partially outside the groove on the upper casting 410, with a portion of its height protruding above the adjacent surface of the upper casting 410. In some embodiments, after the fuel storage tank 400 is installed, the lower isolators 431 and 432 are depressed into their respective grooves, such that their outer surfaces become substantially flush with the adjacent surfaces of the lower casting 420. Similarly, the upper isolator 430 may be depressed into the groove of the upper casting 410, becoming level with the adjacent surface of the upper casting 410. Similarly, as illustrated in FIG. 8, the lower isolator 433 may experience the greatest load due to its central position along the fuel storage tank 400. As a result, the lower isolator 433 may protrude outward from the groove surface more than the other isolators, ensuring it provides sufficient support to accommodate the applied forces.

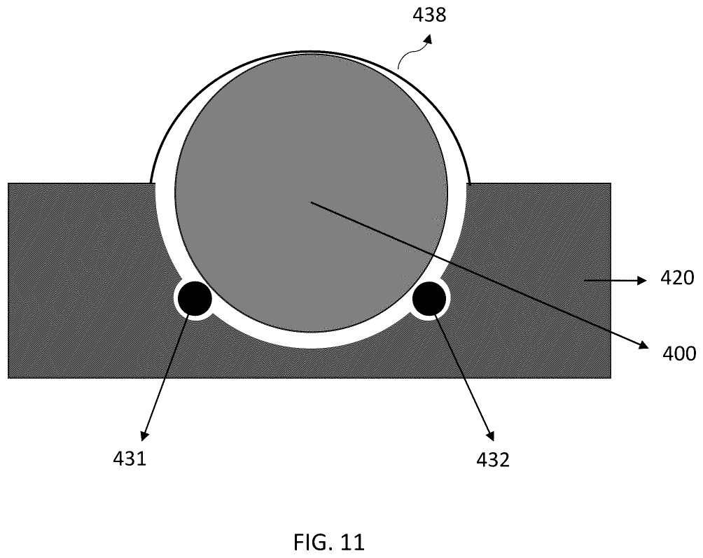

In some embodiments, an upper casting may be omitted to reduce weight and save costs, utilizing only a lower casting 420 for the fuel cell system, as illustrated in FIG. 11. FIG. 11 illustrates a cross-sectional view of an exemplary fuel storage structure and method for a fuel cell system according to embodiments of the present disclosure. Upper mounting may be achieved by using one or more mounting brackets or straps 438, which surround the upper portion of the fuel storage tank 400. The mounting bracket or strap(s) 438 may comprise a single component or multiple components, depending on the system's design requirements. As illustrated in FIG. 11, the two lower mounts 431 and 432 may be positioned symmetrically around the centerline axis of the fuel storage tank 400 to help ensure the fuel storage tank 400 is centered about the opening enclosed by the mounting bracket(s) or strap(s) 438 and the lower casting 420. The two lower mounts 431 and 432 may be cylindrical or rectangular prism in shape. The two lower mounts 431 and 432 may be made from the same appropriate material, such as rubber, or utilize different materials. The selection of material used for the lower mounts, along with the upper mounting bracket(s) or strap(s) 433, the strategic placement of the isolators, and the depth of the isolators, allows for adequate compression to secure the fuel storage tank 400 at the center of the opening enclosed by the upper bracket(s) or strap(s) 433 and lower casting 420. This arrangement also ensures precise control over the location of the fuel storage tank valve. Additionally, this type of isolator helps minimize the transmission of vibrations within the casting, thereby enhancing the stability and performance of the fuel cell system. Furthermore, it accommodates the expansion and contraction of the fuel tank 400 due to environmental temperature changes. FIG. 11 illustrates a configuration with two lower mounts as an example. However, it should be noted that other configurations, as depicted in FIG. 7 through FIG. 10, may also be implemented, allowing for variations in the number, placement, and arrangement of the mounts to suit specific design requirements.

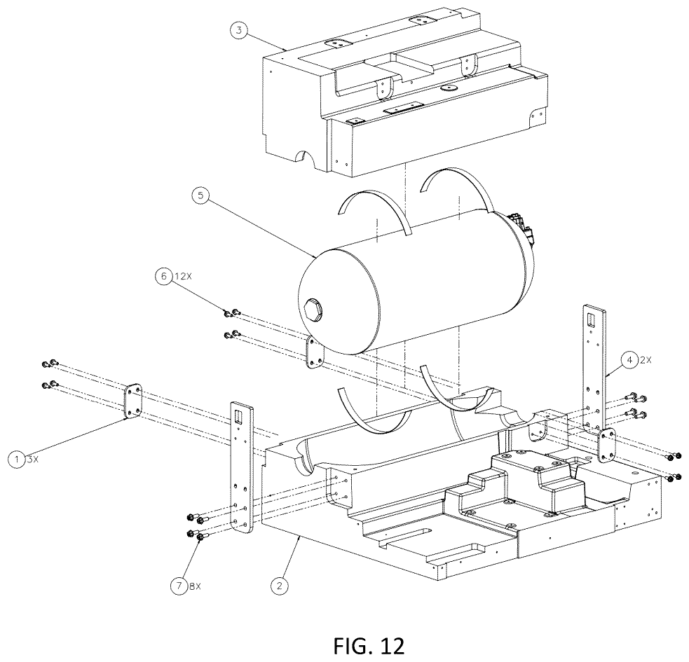

In some embodiments, the isolators may be positioned along the tank's circumference and are designed to conform to the cylindrical surface of the fuel storage tank. FIG. 12 illustrates an exploded view of an exemplary fuel storage structure and method employed in a fuel cell system according to embodiments of the present disclosure. The upper casting 410 may include two parallel grooves that are positioned to align with the upper portion of the circumference of the fuel storage tank 400, conforming to its cylindrical surface to provide secure support and alignment for the upper isolators. The lower casting 420 may comprise two parallel grooves that are positioned to align with the lower portion of the circumference of the fuel storage tank 400, conforming to its cylindrical surface to provide secure support and alignment for the lower isolators. The length of the grooves in the upper casting 410 and lower casting 420 may be equal to or less than half of the circumference of the fuel storage tank 400. The isolators may be rectangular or cylindrical in shape. The upper isolators are securely placed into the grooves in the upper casting 410. The lower isolators are securely placed into the grooves in the lower casting 420. In some embodiments, the length of the upper isolators and the lower isolators is equal to or less than half of the circumference of the fuel storage tank 400. FIG. 12 illustrates a configuration with two upper mounts and two lower mounts as an example, where the tank is supported and secured by these isolators, symmetrically positioned around the tank. However, it should be noted that other configurations, including variations in isolator materials, quantities, locations, and shapes, are possible and may be implemented depending on specific design requirements and structural considerations.

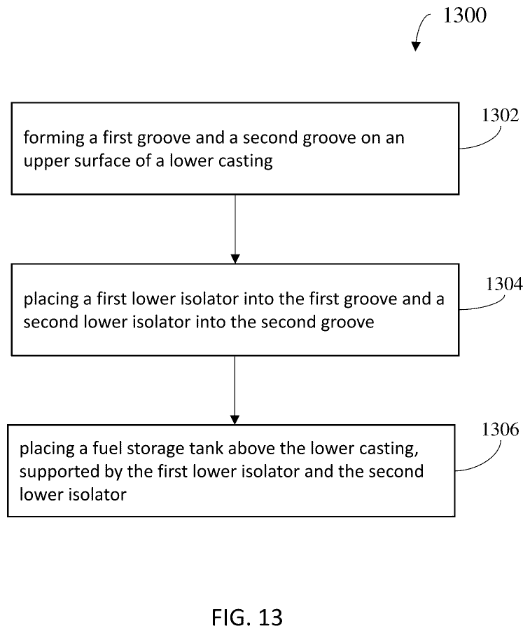

FIG. 13 is a flowchart of an example method 1300 for integrating a fuel storage structure in a fuel cell power system according to embodiments of the present disclosure. This flowchart shown in FIG. 13 is merely an example, which should not unduly limit the scope of the claims. One of ordinary skill in the art would recognize many variations, alternatives, and modifications. For example, various steps illustrated in FIG. 13 may be added, removed, replaced, rearranged and repeated.

The method 1300 may be operative at a fuel storage structure of a fuel cell system, which includes a fuel storage tank, a lower casting, and a plurality of isolators (or mounts) placed within respective grooves on the lower casting.

At step 1302, a first groove and a second groove are formed on an upper surface of a lower casting. At step 1304, a first lower isolator is placed into the first groove and a second lower isolator is placed into the second groove. At step 1306, a fuel storage tank is positioned above the lower casting, supported by the first lower isolator and the second lower isolator.

The method may further comprise forming a third groove on a lower surface of an upper casting; and placing an upper isolator into the third groove. The fuel storage tank is positioned within an opening enclosed by the upper casting and the lower casting, and the upper isolator is parallel to a longitudinal axis of the fuel storage tank.

In some embodiments, the first lower isolator and the second lower isolator are parallel to the longitudinal axis of the fuel storage tank, and symmetrically positioned on opposite sides of the longitudinal axis of the fuel tank.

The method may further comprise forming a fourth groove on an upper surface of the lower casting and placing a third lower isolator within the fourth groove of the lower casting. The third lower isolator is positioned centrally in the lower casting and parallel to the longitudinal axis of the fuel storage tank.

In some embodiments, the upper isolator is configured to be depressed into the third groove on the upper casting, aligning its outer surface with the lower surface of the upper casting. The first lower isolator, the second lower isolator, and the third lower isolator are configured to be depressed into their respective grooves on the lower casting, aligning their outer surfaces with the upper surface of the lower casting. When not depressed, the third lower isolator is configured to protrude outward from the fourth groove beyond the upper surface of the lower casting more than the first lower isolator and the second lower isolator.

In some embodiments, the first lower isolator, the second lower isolator, and the upper isolator are cylindrical in shape.

In other embodiments, the upper isolator is cylindrical in shape, while the first lower isolator and the second lower isolator are rectangular prisms in shape.

In some embodiments, the upper isolator is aligned along an upper portion of a circumference of the fuel storage tank, while the first lower isolator and the second lower isolator are positioned along a lower portion of the circumference of the fuel storage tank.

The method may further comprise placing a bracket or strap to secure the fuel storage tank by encircling an upper portion of the fuel storage tank. The first lower isolator and the second lower isolator are positioned parallel to the longitudinal axis of the fuel storage tank and are symmetrically located on opposite sides of the longitudinal axis of the fuel storage tank.

While the embodiments above show that the fuel storage tank are secured with two or three isolators, various numbers of isolators may be used, which is not limited thereto. A plurality of isolators may be arranged around the fuel storage tank, evenly or in a designated pattern. The isolators may have the same shape, e.g., they are all cylinders or rectangular prisms, or some of the isolators may have different shapes, as shown in FIG. 7. The arrangement, number, dimensions (e.g., length, diameter, thickness, cross-sectional area, etc.) and shapes of the isolators, may be configured based on the applications of the fuel system, the dimensions of the fuel system and the fuel storage tank, transportation requirements, and other applicable factors.

The isolators in the above embodiments may be made from the same appropriate material, such as rubber. The rubber may have various applicable durometer levels. However, in some embodiments, the isolators may utilize different materials allowing for tailored characteristics such as varying levels of elasticity, hardness, or resistance to specific environmental factors. For example, the upper mount(s) may be made of rubber, and the lower mounts may be made of durable plastic, such as Delrin, to meet specific design and functional requirements. This flexibility in material selection enables optimization for diverse operating conditions and enhances the overall performance and longevity of the fuel cell system.

In the above embodiments, the selection of material used for the isolators, the strategic placement of the isolators, and the size of the isolators allow for adequate compression to secure the fuel storage tank 400 at the center of the opening enclosed by the upper casting 410 and lower casting 420. This arrangement also ensures precise control over the location of the fuel storage tank valve and enables secure bolting of the upper casting 410 and lower casting 420 together. This type of isolator also helps minimize the transmission of vibrations within the casting, thereby enhancing the stability and performance of the fuel cell system. Furthermore, it accommodates the expansion and contraction of the fuel tank 400 due to environmental temperature changes.

In some embodiments, the isolators may be affixed to the castings or mounting surfaces using bolts or adhesive, ensuring enhanced stability and secure attachment within the fuel storage assembly. In some embodiments, the isolators may be secured using pre-applied pressure-sensitive adhesive (PSA) integrated into the specified component. This approach-facilitates precise placement and provides permanent securement within the system during assembly. Factors to consider when selecting isolators may include casting tolerance and tank tolerance stack-up, the designed isolator gap spacing, the compressibility factor of the isolator, and the durometer of the isolator material.

Features described in the context of one embodiment may be used in combination with other embodiments. For example, each of the optional features described above in the context of the apparatus may be used in combination with the system.

Those of ordinary skill in the art would recognize that various embodiments, alternatives and modifications may be made for designating the fans for different tasks and for controlling the fans, without departing from the spirit and principle of the present disclosure.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A fuel storage structure in a fuel cell system, comprising:
a lower casting comprising a first groove and a second groove formed on an upper surface of the lower casting;
a first lower isolator positioned within the first groove and a second lower isolator positioned within the second groove; and
a fuel storage tank positioned above the lower casting, wherein the fuel storage tank is supported by the first lower isolator and the second lower isolator.

2. The fuel storage structure of claim 1, wherein the first lower isolator and the second lower isolator are positioned parallel to a longitudinal axis of the fuel storage tank.

3. The fuel storage structure of claim 2, further comprising:
an upper casting, wherein the fuel storage tank is positioned within an opening enclosed by the upper casting and the lower casting; and
an upper isolator positioned within a third groove on a lower surface of the upper casting, wherein the upper isolator is positioned parallel to the longitudinal axis of the fuel storage tank.

4. The fuel storage structure of claim 3, wherein the first lower isolator and the second lower isolator are symmetrically positioned on opposite sides of the longitudinal axis of the fuel storage tank and are cylindrical in shape.

5. The fuel storage structure of claim 3, wherein the first lower isolator and the second lower isolator are symmetrically positioned on opposite sides of the longitudinal axis of the fuel storage tank and are rectangular prisms in shape.

6. The fuel storage structure of claim 3, further comprising a third lower isolator, a fourth lower isolator, and a fifth lower isolator, each positioned within a respective groove in the lower casting and aligned parallel to the longitudinal axis of the fuel storage tank, wherein:
the first lower isolator and the second lower isolator are positioned on a left side of the lower casting;
the third lower isolator and the fourth lower isolator are positioned on a right side of the lower casting; and
the fifth lower isolator is positioned centrally in the lower casting and along the longitudinal axis of the fuel storage tank, and wherein a left end of the fifth lower isolator is aligned with a centerline of the first lower isolator and the second lower isolator, and a right end of the fifth lower isolator is aligned with a centerline of the third lower isolator and the fourth lower isolator.

7. The fuel storage structure of claim 2, further comprising a bracket or strap configured to secure the fuel storage tank by encircling an upper portion of the fuel storage tank.

8. The fuel storage structure of claim 1, further comprising an upper isolator positioned within a third groove on an upper casting and aligned along an upper portion of a circumference of the fuel storage tank, while the first lower isolator and the second lower isolator are aligned along a lower portion of the circumference of the fuel storage tank.

9. A method for integrating a fuel storage structure in a fuel cell system comprising:
forming a first groove and a second groove on an upper surface of a lower casting;
placing a first lower isolator into the first groove and a second lower isolator into the second groove; and
placing a fuel storage tank above the lower casting, supported by the first lower isolator and the second lower isolator.

10. The method of claim 9, further comprising:
forming a third groove on a lower surface of an upper casting; and
placing an upper isolator into the third groove, wherein the fuel storage tank is positioned within an opening enclosed by the upper casting and the lower casting, and the upper isolator is parallel to a longitudinal axis of the fuel storage tank.

11. The method of claim 10, wherein the first lower isolator and the second lower isolator are parallel to the longitudinal axis of the fuel storage tank, and symmetrically positioned on opposite sides of the longitudinal axis of the fuel storage tank.

12. The method of claim 11, further comprising:
forming a fourth groove on an upper surface of the lower casting; and
placing a third lower isolator within the fourth groove of the lower casting, wherein the third lower isolator is positioned centrally in the lower casting and parallel to the longitudinal axis of the fuel storage tank.

13. The method of claim 12, wherein:
the upper isolator is configured to be depressed into the third groove on the upper casting to align its outer surface with the lower surface of the upper casting;
the first lower isolator, the second lower isolator, and the third lower isolator are configured to be depressed into their respective grooves on the lower casting to align their outer surfaces with the upper surface of the lower casting; and
the third lower isolator, when not depressed, is configured to protrude outward from the fourth groove beyond the upper surface of the lower casting by a greater distance than the first lower isolator and the second lower isolator.

14. The method of claim 11, wherein the first lower isolator, the second lower isolator and the upper isolator are cylindrical in shape.

15. The method of claim 11, wherein:
the upper isolator is cylindrical in shape; and
the first lower isolator and the second lower isolator are rectangular prisms in shape.

16. The method of claim 10, wherein the upper isolator is aligned along an upper portion of a circumference of the fuel storage tank, while the first lower isolator and the second lower isolator are positioned along a lower portion of the circumference of the fuel storage tank.

17. The method of claim 9, further comprising placing a bracket or strap to secure the fuel storage tank by encircling an upper portion of the fuel storage tank, wherein the first lower isolator and the second lower isolator are positioned parallel to a longitudinal axis of the fuel storage tank, and are symmetrically located on opposite sides of the longitudinal axis of the fuel storage tank.

18. A fuel cell system, comprising:
a fuel storage tank;
a lower casting positioned under the fuel storage tank;
a plurality of lower isolators, each positioned within a respective groove in the lower casting and aligned parallel to a longitudinal axis of the fuel storage tank;
a pressure regulator configured to control a fuel pressure within the fuel cell tank;
a fuel cell stack configured to receive fuel from the fuel storage tank and generate electrical power; and
a system controller configured to monitor and control the operation of the fuel cell system.

19. The fuel cell system of claim 18, further comprising:
an upper casting, wherein the fuel storage tank is positioned within an opening enclosed by the upper casting and the lower casting; and
an upper isolator positioned within a groove on a lower surface of the upper casting, wherein the upper isolator is parallel to the longitudinal axis of the fuel storage tank.

20. The fuel cell system of claim 18, further comprising:
a bracket or strap configured to secure the fuel storage tank by encircling an upper portion of the fuel storage tank, wherein the plurality of lower isolators are cylindrical in shape, and lengths of the plurality of lower isolators are equal to or less than a length of a straight cylindrical portion of the fuel storage tank.
